(19) United States
(12) Patent Application Publication
(10) Pub. No.: US 2026/0253388 A1
(43) Pub. Date: Aug. 27, 2026

(54) METHOD FOR SETTING THE TIME ON A WATCH POSITIONED ON A SUPPORT, IMPLEMENTING NEURAL NETWORKS

(71) Applicant: Montres Breguet SA, L'Abbaye (CH)

(72) Inventors: Jérôme FAVRE, Neuchâtel (CH); Gregory KISSLING, La Neuveville (CH); Antoine BILLOD, Villers-le-Lac (FR)

(73) Assignee: Montres Breguet SA, L'Abbaye (CH)

(21) Appl. No.: 19/535,317

(22) Filed: Feb. 10, 2026

(30) Foreign Application Priority Data
Feb. 26, 2025 (EP) 25160353.6

(51) Int. Cl. G06V 10/764; G04B 5/02; G06V 10/82

(52) U.S. Cl. CPC G06V 10/765; G04B 5/02; G06V 10/82

(57) ABSTRACT

A method for setting the time on a watch (10) positioned on a support (20), according to a reference time provided by a reference clock. The method includes: acquiring a reference image of the watch (10); determining the time indicated by the watch in the reference image using an image recognition model implementing at least one neural network driven from a database (50) including images of labelled watches that differ from each other and for which each label includes representative information about the time indicated by the watch as shown in the image with which it is associated; and setting the time on the watch via an oscillatory rotational drive on the support on which the watch is positioned, at a frequency intended to slow or accelerate the rate of the watch so that it reaches the reference time.

### CROSS REFERENCE TO RELATED APPLICATIONS

This application claims priority to European Patent Application No. 25160353.6 filed February 26, 2025, the entire contents of which are incorporated herein by reference.

### Technical field of the Invention

The invention relates to the field of horology and, in particular, to a method for setting the time on a watch positioned on a support, implementing neural networks.

### Technological background

Documents EP4095623 and WO2012126978A1 describe winding mechanisms designed for holding a watch and setting its time. To this end, these winding mechanisms implement methods for telling the time indicated by the watch they support by acquiring an image of the front of the watch, namely, the dial and hands, and by determining the position of the hands. This approach has the advantage of being relatively simple to implement and is reliable when the model of the watch in question and the lighting conditions do not vary.

However, this method of telling the time is ineffective when it comes to telling the time indicated by a watch whose image has not previously been stored in the image database. Moreover, this method does not allow any variation in the lighting conditions in order to be used.

There is a need for a method of telling the time displayed by a watch, regardless of its model, that is, regardless of its appearance, and regardless of the lighting conditions in which the watch is found when one wants to know what time it is displaying.

### SUMMARY OF INVENTION

To this end, the invention relates to a method for setting the time on a watch positioned on a support, according to a reference time provided by a reference clock, comprising the following steps:

acquiring, by means of a vision system, an image of the watch, the latter constituting a reference image, and

determining the time indicated by the watch in the reference image using an image recognition model implementing at least one neural network driven from a database comprising images of labelled watches that differ from each other and for which each label comprises representative information about the time indicated by the watch as shown in the image with which it is associated,

setting the time on the watch via an oscillatory rotational drive of the support on which the watch is positioned, at a frequency intended to slow or accelerate the rate of the watch so that it reaches the reference time.

In particular embodiments, the invention can further comprise one or more of the following features, taken separately or in any technically possible combination.

In particular embodiments, the method comprises a verification step in which the consistency of the result obtained from the determination step is verified, comprising:

a series of successive operations to determine the time indicated by the watch at several time points T₀,..., Tₙ within a predefined time interval, each time point being characterised by a known reference time,

a comparison operation in which, for each time point T₀, ..., Tₙ, the determined time is compared with the reference time so as to obtain a representative value of the difference between the determined time and the reference time,

a validation operation in which, if for at least one of the time points T_{0,} ..., Tₙ the representative value of the difference between the determined time and the reference time is greater than a threshold value, the result obtained following the determination step is disregarded and the verification step is repeated.

In particular embodiments, to create the database, photographs of a watch are taken at regular intervals for a predetermined period of time so as to obtain a desired number of images, and each image is assigned a datum representative of the time indicated by the watch shown in the reference image.

In particular embodiments, the watch is a mechanical watch driven by a support in an oscillatory rotational movement at a nominal frequency corresponding to a theoretical frequency at which the oscillator in the watch is supposed to oscillate.

In particular embodiments, the determination step comprises a detection operation for detecting the presence of a watch on the support, the execution of the determination step being continued if the detection operation detects the presence of a watch, and not being continued otherwise.

In particular embodiments, the detection operation for detecting the presence of a watch on the support is executed by a specific neural network.

In particular embodiments, the determination step comprises a geometric transformation operation on the reference image using a neural network of its own.

In particular embodiments, the determination step comprises an hour and minute identification operation for identifying the hours and minutes indicated by the watch in the reference image using its own neural network associating said reference image with one class in a set of classes comprising every possible hour and minute combination.

In particular embodiments, the determination step comprises a seconds identification operation for identifying the seconds indicated by the watch in the reference image using its own neural network associating said reference image with one class in a set of classes comprising sixty different values representing the successive seconds constituting one minute.

In particular embodiments, the reference clock is formed by a reference watch, the reference time being determined by the image recognition model following a step in which the vision system acquires an image of the reference watch.

### BRIEF DESCRIPTION OF THE FIGURES

Other features and advantages of the invention will become apparent from the following detailed description, given by way of non-limiting examples, with reference to the attached drawings in which:

FIG. 1 is a schematic representation of a support on which a watch has been positioned to be time-set by implementing the method according to the invention,

FIG. 2 is a flow chart of the steps in an exemplary embodiment of the method according to the invention.

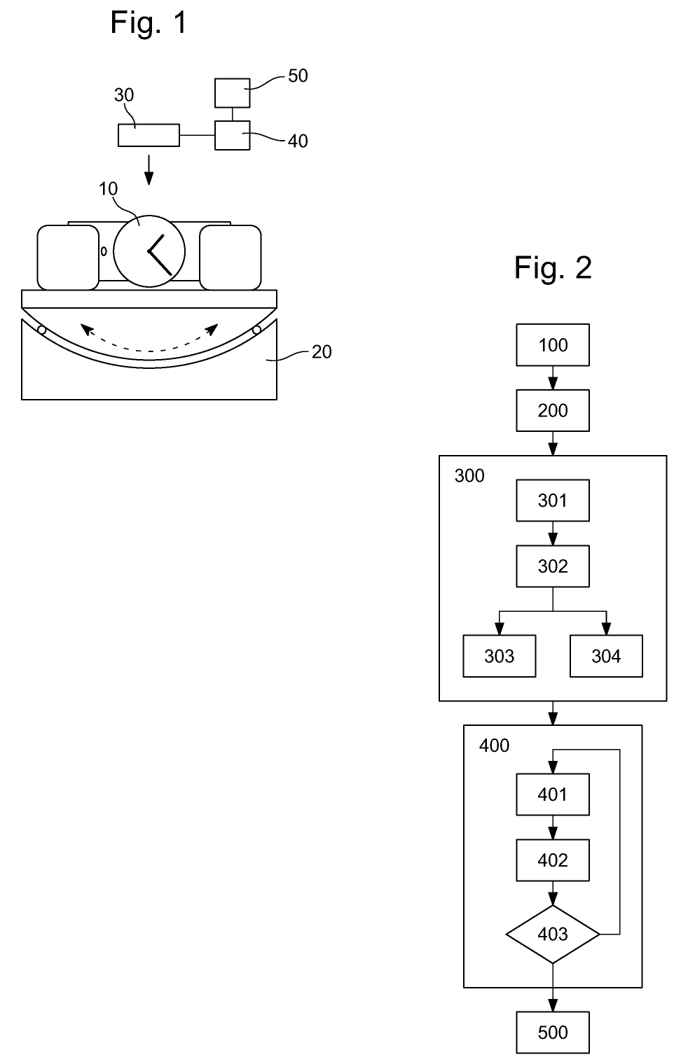

It should be noted that the figures are not necessarily drawn to scale for clarity reasons.

### DETAILED DESCRIPTION OF THE INVENTION

The invention relates to a method for setting the time on a watch 10 positioned on a support 20, according to a reference time indicated by a reference clock. Firstly, when implementing the method according to the invention, the objective is to obtain the time indicated by the watch 10. The reference time corresponds, for example, to the current time and is provided by an atomic clock, a reference watch, etc.

To this end, the method comprises a step in which a vision system (30) acquires (200) an image of the watch (10) to determine the time it is indicating. The image of the watch 10 constitutes a reference image for the subsequent steps in the method.

The vision system 30 is known to a person skilled in the art and is, for example, formed in particular by a camera or a photographic apparatus. The acquired image is saved in a memory by a data processing unit 40, such as a processor.

Thereafter, a step for determining 300 the time indicated by the watch 10 in the reference image is executed by the data processing unit 40 using an image recognition model implementing at least one neural network driven from a database 50.

The database 50 is generated in a preliminary creation step 100 and comprises images of watches, all differing from each other. The images are labelled such that each label comprises representative information about the time indicated by the watch shown in the image with which it is associated.

The images can be generated by an image generation algorithm and/or by taking photographs of a functioning watch.

In particular, photographs can be taken at regular intervals for a predetermined amount of time in order to obtain a desired number of images.

In this case, the rate of the watch can advantageously be servo-controlled at a nominal frequency, corresponding to the theoretical frequency at which the oscillator of the watch, in other words the sprung balance assembly, is supposed to oscillate, to control the rate of the watch and guarantee its chronometric precision. An example of such servo-controlling is described in EP3410235.

The determination step 300 can advantageously comprise a detection operation 301 for detecting the presence of a watch 10 on the support 20. The detection operation 301 for detecting the presence of a watch 10 on the support 20 can be implemented by a specific neural network or by sensors connected to the data processing unit 40. The result of the detection operation 301 dictates the execution of the determination step 300, as described in more detail below.

To improve the chances of success in accurately determining the time indicated by the watch 10, regardless of its position relative to the vision system 30, the determination step 300 can advantageously comprise, after the detection operation 301, if appropriate, a geometric transformation operation 302 on the reference image by means of its own neural network. Such a neural network is known as a "Spatial Transformer Network." The geometric transformation operation 302 on the reference image is executed if the detection operation 301 detects the presence of a watch 10, and is not executed otherwise.

Advantageously, as shown in FIG. 2, the determination step 300 can comprise an operation for identifying the hour and minute 303 indicated by the watch 10 on the reference image, by a specific neural network associating said reference image with one class in a set of classes. These classes each correspond to one of the potential time combinations from among twelve hours and sixty minutes, to wit, seven hundred and twenty classes.

In this hour and minute identification operation 303, the second indicated by the watch 10 on the reference image is not identified.

In fact, the second is advantageously identified in a separate seconds identification operation 304 using its own neural network associating said reference image with one class in a set of classes comprising sixty different values representing the successive seconds constituting one minute.

Determining the hour-minute couple and the second separately makes it possible, on one hand, to minimise the size of the database 50, and on the other hand to minimise the resources required to implement the neural networks for identifying the minute, hour and second indicated by the watch 10. Furthermore, the specific neural network for identifying the seconds is more efficient in that it is specialised and can identify the seconds regardless of the type of seconds display with which the watch 10 is fitted, such as small seconds in a sub-dial or central seconds, and regardless of the appearance of the sub-dial or of the dial.

Preferentially, as shown in FIG. 2, the method according to the invention comprises a step 400 for verifying the consistency of the result obtained from the determination step 300.

This verification step 400 is carried out by executing a series of successive operations 401 to determine the time indicated by the watch 10 at several time points T₀, ..., Tₙ within a predefined time interval. The time points T₀,..., Tₙ are spaced apart by chosen durations, which may or may not be identical, for example by a few seconds, for example between five and ten seconds. By way of example, n = 3, such that the series comprises four successive operations for determining the time indicated by the watch 10. Each time point T₀,..., Tₙ is characterised by a known reference time, provided by a reference clock, such as a reference watch, an atomic clock, etc.

At the end of the series of successive operations 401 to determine the time indicated by the watch 10, a comparison operation 402 is executed, in which, for each time point T₀, ..., Tₙ, the determined time is compared with the reference time so as to obtain a representative value of the difference between the determined time and the reference time.

The verification step 400 then comprises a validation operation 403 consisting in running the series of successive operations 401 again while disregarding the result obtained in the determination step 300, provided that for at least one of the time points T₀, ..., Tₙ the representative value of the difference between the determined time and the reference time is greater than a threshold value. The number of n = 3 occurrences makes it possible to eliminate any likelihood of the determined time coinciding by chance with the reference time, while keeping the number of operations and thereby the length of the series of successive operations 401 to a minimum.

If the representative value of the difference between the determined time and the reference time is less than the threshold value, the result obtained in the determination step 300 is then validated and the implementation of the method according to the invention is continued.

The verification step 400 ensures that the time determined in the determination step 300 corresponds exactly to the time actually indicated by the watch 10.

In a second step, watch 10 is time-set.

The watch 10 can be time-set by servo-controlling the rate at which the watch 10 functions, and in particular the operating frequency of its oscillator.

More specifically, the watch 10 is time-set in a time-setting step 500 via an oscillatory rotational drive of the support 20 on which the watch 10 is positioned, at a frequency intended to slow or accelerate the rate of the watch so that it reaches the reference time. More specifically, the operating frequency of the oscillator in the watch 10 is increased or decreased until the time indicated by the watch 10 corresponds to the reference time, which is preferentially the current time.

This time-setting step 500 can involve executing, preferentially continuously, the determination step 300 so as to be able to identify the instant in which the watch 10 reaches the reference time. Alternatively, the duration of the time setting step 500 is calculated on the basis of the difference between the time indicated by the watch 10 and the reference time, taking account of the fact that the reference time changes over time and of the correction velocity of the time indicated by the watch 10.

It should be noted that the time can be set by acting on the watch's control organs, such as a crown or a button, via appropriate connecting means controlled by the data processing unit 40.

Once the watch 10 has been time-set, the support 20 can be driven so as to oscillate at the nominal frequency, thus enabling the watch 10 to maintain excellent chronometric precision.

As is known from the prior art, the nominal frequency is determined by measuring the oscillation frequency of the oscillator in the watch 10 using a suitable vibration sensor, such as a microphone or contact sensor, and comparing it with several predetermined values, for example, 2.5 Hz, 3 Hz and 4 Hz, stored in a memory module. These predetermined values represent potential reference frequencies. For example, the predetermined value closest to the measured oscillator frequency is chosen as the nominal frequency value by the data processing unit 40.

In one embodiment of the invention, the reference clock is a reference watch and the reference time is determined by the image recognition model described above, following a step in which the vision system 30 acquires an image of the reference watch. The image of the reference watch can be acquired by the same camera as the one used to acquire the image of watch 10, or it can be acquired by a specific camera. It is obvious that the determination step is carried out before the step in which the watch 10 is time-set 500.

In this exemplary embodiment, the chronometric precision of the reference watch is advantageously substantially greater than that of the watch 10 to be time-set.

The configuration and arrangement of the electronic components are not described in detail in this text as they can, as such, be arrived at by the person skilled in the art.

More generally, it should be noted that the embodiments and uses considered above have been described by way of non-limiting examples, and that other variants are therefore conceivable.

In particular, several watches can be simultaneously time-set using the present method, according to a reference time provided by the same reference clock.

It should also be noted that the time-setting method as described above can be implemented in parallel with an optimised winding of the one or more watches, so that they are always ready for use by the wearer, as described in EP3410235, EP3410236 and EP3422119.

1. A method for setting the time on a watch positioned on a support, according to a reference time provided by a reference clock, comprising the following steps:
acquiring, by means of a vision system, an image of the watch, the latter constituting a reference image, and
determining the time indicated by the watch in the reference image using an image recognition model implementing at least one neural network driven from a database comprising images of labelled watches that differ from each other and for which each label comprises representative information about the time indicated by the watch as shown in the image with which it is associated,
setting the time on the watch via an oscillatory rotational drive on the support on which the watch is positioned, at a frequency intended to slow or accelerate the rate of the watch so that it reaches the reference time.

2. The method according to claim 1, further comprising a verification step in which the consistency of the result obtained from the determination step is verified, comprising:
a series of successive operations to determine the time indicated by the watch at several time points within a predefined time interval, each time point being characterised by a known reference time,
a comparison operation wherein, for each time point, the determined time is compared with the reference time so as to obtain a representative value of the difference between the determined time and the reference time,
a validation operation wherein, if for at least one of the time points the representative value of the difference between the determined time and the reference time is greater than a threshold value, the result obtained following the determination step is disregarded and the verification step is repeated.

3. The method according to claim 1, wherein, to create the database, photographs of a watch are taken at regular intervals for a predetermined period of time so as to obtain a desired number of images, and each image is assigned a datum representative of the time indicated by the watch shown in the reference image.

4. The method according to claim 3, wherein the watch is a mechanical watch driven by a support in an oscillatory rotational movement at a nominal frequency corresponding to a theoretical frequency at which the oscillator in the watch is supposed to oscillate.

5. The method according to claim 1, wherein the determination step comprises a detection operation for detecting the presence of a watch on the support, the execution of the determination step being continued if the detection operation detects the presence of a watch, and not being continued otherwise.

6. The method according to claim 5, wherein the detection operation for detecting the presence of a watch on the support is executed by a specific neural network.

7. The method according to claim 1, wherein the determination step comprises a geometric transformation operation on the reference image using a neural network of its own.

8. The method according to claim 5, wherein the determination step comprises an hour and minute identification operation for identifying the hours and minutes indicated by the watch in the reference image using its own neural network associating said reference image with one class in a set of classes comprising every possible hour and minute combination.

9. The method according to claim 5, wherein the determination step comprises a seconds identification operation for identifying the seconds indicated by the watch in the reference image using its own neural network associating said reference image with one class in a set of classes comprising sixty different values representing the successive seconds constituting one minute.

10. The method according to claim 1, wherein the reference clock is formed by a reference watch, the reference time being determined by the image recognition model following a step wherein the vision system acquires an image of the reference watch.
